(19) United States
(12) Patent Application Publication
(10) Pub. No.: US 2024/0257061 A1
(43) Pub. Date: Aug. 1, 2024

(54) GUIDED REMINDERS FOR PATENT PROSECUTION METHOD AND TOOL

(71) Applicant: Black Hills IP Holdings, LLC., Minneapolis, MN (US)

(72) Inventor: Steven W. Lundberg, Edina, MN (US)

(21) Appl. No.: 18/429,197

(22) Filed: Jan. 31, 2024

Related U.S. Application Data
(60) Provisional application No. 63/442,439, filed on Jan. 31, 2023.

(51) Int. Cl. G06Q 10/109; G06Q 50/18

(52) U.S. Cl. CPC G06Q 10/109; G06Q 50/184

(57) ABSTRACT

Various embodiments disclosed relate to a guided reminder tool and method for use with a docketing system. The present disclosure includes a method of providing recommendations for project tasks by reminding a user of an upcoming task with an associated deadline, providing information related to the upcoming task, producing one or more considerations for the user related to the upcoming task and the associated deadline, receiving input from the user related to the one or more considerations, weighing the one or more considerations according to predetermined parameters, and recommending a course of action related to the upcoming task accordingly.

### CLAIM OF PRIORITY

This application claims the benefit of priority under 35 U.S.C. § 119(e) to U.S. Provisional patent application Ser. No. 63/442,439, filed on Jan. 31, 2023, which is incorporated by reference herein in its entirety.

### BACKGROUND

In a business, docketing systems can be used to track workflow deadlines, tasks, and progress. For example, in a given project, a docketing system can track when the project is opened, what initial filings are due when, and correspondence coming in regarding that project. The docketing system can additionally be used to record deadlines and flag correspondence or documents that may require a response. However, in a general docketing setting, a large number of items and tasks are incoming and often need to be sorted during docketing. Typically, many deadlines and reminders are created to manage such a system and portfolio.

### SUMMARY OF THE DISCLOSURE

A method of providing recommendations for project tasks with a guided reminder tool can include: reminding a user of an upcoming task with an associated deadline; providing information related to the upcoming task on a guided reminder tool user interface; producing one or more considerations for the user related to the upcoming task and the associated deadline; receiving input from the user related to the one or more considerations; weighing the one or more considerations according to predetermined parameters; and recommending a course of action related to the upcoming task and the associated deadline to the user on the guided reminder tool user interface, wherein recommending the course of action is based on the one or more considerations.

A docketing system can include: a guided reminder tool comprising: an automated or semi-automated docketing system; a docket task reminder tool in communication with the docketing system, the docketing task reminder tool for providing reminders to a user regarding docket tasks; the guided reminder tool configured to work with the docket task reminder tool to provide user-interactive recommendations for docket tasks.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 depicts a schematic of an automated patent docketing system in an example.

FIG. 2 depicts third party data sources in an example.

FIG. 3 is a schematic diagram of a docketing environment including a guided reminder tool in an example.

FIG. 4 is a schematic diagram of a docketing system including a guided reminder tool in an example.

FIG. 5 depicts potential considerations used with a guided reminder tool in an example.

FIG. 6 depicts a schematic of a method of using a guided reminder tool in an example.

FIG. 7 depicts a method of using a guided reminder tool in an example.

FIG. 8 depicts a method of using a guided reminder tool in an example.

FIG. 9 depicts a method of using a guided reminder tool in an example.

FIG. 10 depicts a computer system in an example.

### DETAILED DESCRIPTION

The present disclosure describes, among other things, a guided reminder tool and associated methods. The guided reminder tool can be used in conjunction with an automated or semi-automated docketing system to help provide recommendations and insight to a user working on a particular project with an upcoming task deadline.

The present disclosure provides methods and systems for workflow management in a patent prosecution context. The discussed methods and approaches leverage a computer and a data-driven structured workflow management tool to provide a patent practitioner with pertinent information regarding an upcoming deadline or task in a pending patent case, and in the context of that reminder, help provide automated recommendations and analysis to aid in a user's decision-making.

As used herein, “electronic communication” refers to an electronic message or a method of exchanging messages between people using electronic devices.

As used herein, “template” can include a preset format for a document or file, used so that the format does not have to be recreated each time it is used. In some cases, a template can include one or more fields to be filled out.

As used herein, “application” or “program” can include a program or piece of software designed and written to fulfill a particular purpose of the user, such as a database application.

As used herein, “associate” can include a partner or colleague in business or at work, either internal or external.

As used herein, “unstructured text” or “unstructured data” refers to data that is not organized in a standard format, for example, text in the body of an electronic communication.

As used herein, “structured text” or “structured data” refers to data that is organized in a standard format such that a recipient may read the data and institute an automated computing system action without human interpretation of the data.

As used herein, “scraping”, “web scraping”, “data scraping”, or “web crawling” can refer to automatically mining or collecting data or information, such as from a database or from the internet.

As used herein, “file” or “matter” can refer to a particular project, enterprise, or undertaking being worked on by an individual or a collaborative group, planned and designed to achieve a particular aim.

As used herein, “official record,” or “file history,” can refer to data about a file or matter denoting evidence about past events or tasks within that file or matter, such as an electronic record of previous events in the file or matter. An “official record” can be stored with and maintained by an overseeing agency or organization, such as a governmental organization.

As used herein, “database”, can refer to a structured set of data, such as held in a computer or on the internet, that can be accessible in various ways.

As used herein, “deadline” refers to a target completion date. Deadlines may be set internally, externally, by a third party, or by a governmental agency.

As used herein, “reminder” refers to a prompt or message to a user that indicates a task to be completed.

As used herein, “extension” refers to an extension or postponement of a deadline. For example, an extension may be movement of a deadline date to a later time, for the payment of a fee with a governmental entity.

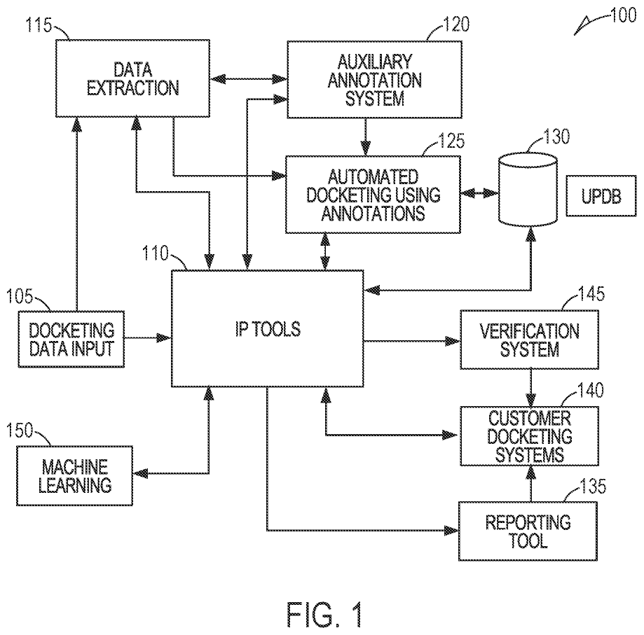

FIG. 1 is a block diagram of a docketing system 100 in an example. The docketing system 100 can be automated or semi-automated. The docketing system 100 can include docketing data input 105, docketing manager 110, data extraction system 115, auxiliary annotation system 120, automated docketing using annotations 125, Universal Procedures Database 130, reporting tool 135, customer docketing system 140, verification system 145, and machine learning model system 150.

The automated docketing system 100 can receive documents from third-party sources including third-party docketing systems and/or customer data as docketing data input 105. The docketing manager system 110 can process the received documents to provide to a customer docketing system 140 and prepare the documents for data extraction by the data extraction system 115 as needed.

The data extraction system 115 can perform Optical Character Recognition (OCR) on the received documents from the docketing manager system 110 to extract data, read checkboxes, extract lists, and identify documents where possible. The docketing manager system 110 can also integrate with a Universal Procedures Database (UPDB) 130 to provide automated docketing by an automated docketing tool 125. The automated docketing tool 125 processes received documents based on additional annotations added to the documents through complex data extraction performed by the Auxiliary Annotation System (AAS) 120.

The AAS 120 may further identify the received documents without using an OCR. To manage this process, the docketing manager system 110 can receive frequent updates of docketing procedure rules including configuration data and updates the UPDB 130 with universal procedure codes (UPCs) as appropriate. The UPCs can be used in conjunction with customer specific codes, checklists, and templates. The rules can specify how to fill in the templates and how to complete customer-specific procedures such as how to docket documents into a customer docketing system 140, for example. The template can be filled out by pulling in attributes from the annotations in a document.

The docketing manager system 110 can receive or intake documents and docketing data from several different sources of docketing data input 105, validate the docketing items against entries in a customer's docketing system 140, and communicate those documents to the customer's docketing system 140 via a unified interface. The docketing manager system 110 can also route documents and associated docketing data through the data extraction system 115 and the AAS 120 and organizes the returned metadata and annotations. The docketing manager system 110 thus can provide a breakout between the metadata and the document text.

The docketing manager system 110 can also keep records and communicate with third-party application programming interfaces (APIs) to push the docketing data and documents automatically where allowed. Otherwise, the docketing manager system 110 can present the documents to human docketers to docket. The docketing manager system 110 may also issue reports upon request.

The docketing manager system 110 can be integrated with a customer's existing docketing system (e.g., FOUNDATIONIP®), semi-integrated (e.g., CPI, ANAQUA®, etc.), may provide a virtual host that does not talk at all to the customer's existing docketing system (e.g., IP Manager, MEMOTECH™), or may provide outputs in spreadsheet form for use by a docketing administrator to update a customer's docketing system 140.

If the docketing manager system 110 and the customer's docketing system are not integrated, the data output of automated docketing system 100 may be presented to a human docketer for manual entry. For example, the human docketer may implement macros that interface with the customer's docketing system 140 to populate the received data into a customer's docketing system 140.

On the other hand, if the docketing manager system 110 and a customer docketing system 140 are integrated or semi-integrated, the data output may be processed to determine if any data is missing to automate the docketing process. If anything is missing, the human docketer can add that information before the automated docketing process may proceed further or the data may be auto-populated and mapped to the template from the UPDB 130.

The automated docketing system 100 can also perform several post-docketing actions, such as sending docketing reports/details to an external verification system 145 that uses a set of rules to verify proper docketing in a host system. The verification system 145 can verify that the data is correctly added to an external customer's docketing system 140. For example, the verification system 145 can pull data from the AAS 120, the docketing manager system 110, and a customer's docketing system 140 to compare what is present to what is expected to be present in the respective systems.

The automated docketing system 100 may also provide automated email “report out” notifications to customers by implementing a reporting tool 135 that specifies docketing actions based on UPDB template configurations. The reporting tool 135 can also provide completed docketing reports to customers either directly or via a customer's docketing system 140.

In some cases, machine learning techniques may be used to generate annotations. For example, a database of past documents that have been identified may be provided by the docketing manager system 110 and used as a data warehouse to train and improve machine learning models by creating a training set for the machine learning model. Over time, the machine learning model system 150 can learn which PTO IDs to use for which documents, which document in a bundle of documents may be used to characterize the bundle, and provide predicted PTO IDs for the received documents. The machine learning model system 150 can also establish rule engine prediction capabilities for received documents that test the classifications.

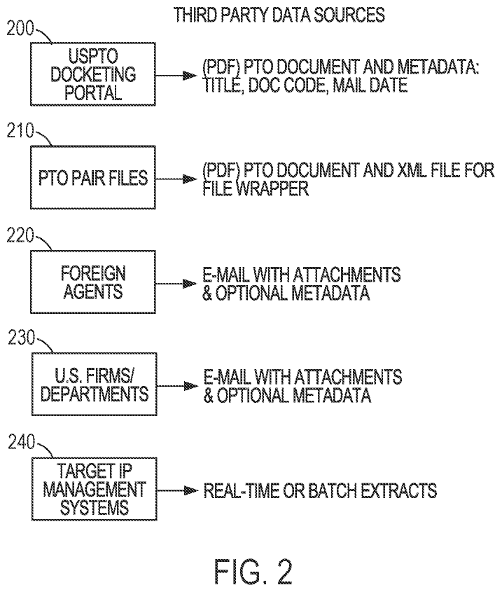

FIG. 2 illustrates sample third-party data sources that provide docketing data input 105 for an automated docketing system 100 implemented for managing patent portfolios in an example. As illustrated in FIG. 2, the third-party data sources may include a national patent or trademark office (PTO) docketing portal 200, which provides documents from the PTO in portable document format (PDF) and includes metadata identifying the title, document code, and mail date for the corresponding document. The third-party data sources may further include PTO patent application Information Retrieval (PAIR) extensible markup language (XML) files 210, which provide documents from the PTO in PDF and includes an XML file for patent file wrappers. The third-party data sources may also include foreign agents 220 who provide emails with attachments and optional metadata.

Foreign agents 220 may also provide hard copy documents that may be scanned for data entry. Similarly, law firms and/or corporate law departments 230 may provide emails with attachments and optional metadata as well as hard copy documents that may be scanned for data entry. Also, third-party docketing systems 240 may provide real-time or batch extracts of data for entry into a docketing management system.

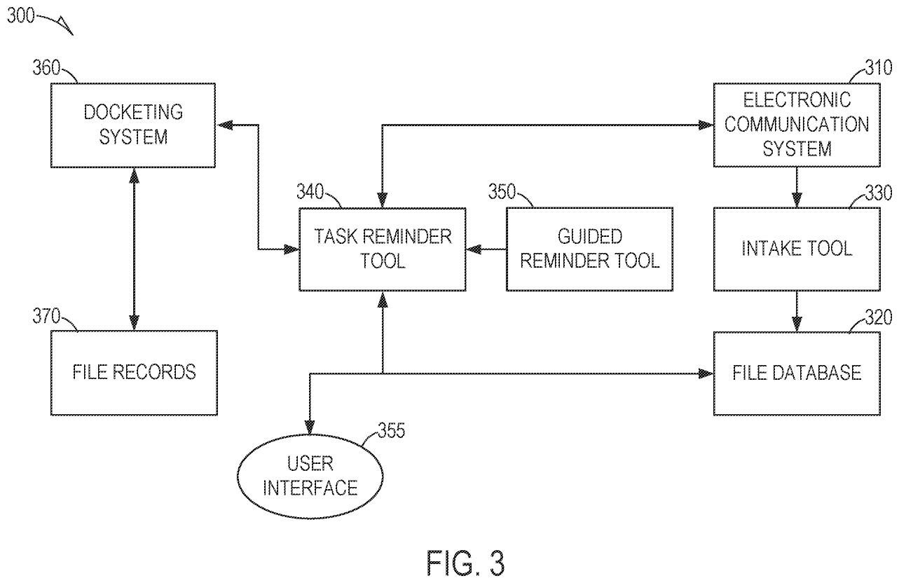

FIG. 3 is a schematic diagram of a docketing environment 300 including a guided reminder tool 350 and a task reminder tool 340.

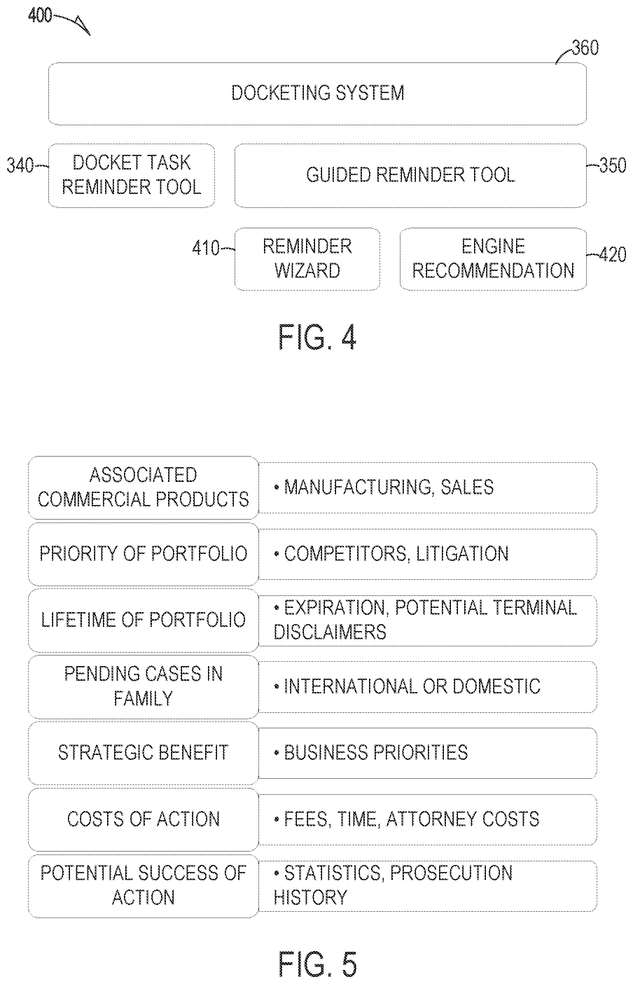

FIG. 4 is a schematic diagram of a docketing system 400 including a guided reminder tool 350 in an example. FIG. 3 and FIG. 4 will be discussed together.

The guided reminder tool 350 can be used in conjunction with the task reminder tool 340 to help provide reminders of tasks and deadlines to a user. The guided reminder tool 350 can further provide analysis to the user to aid in decision making regarding the upcoming tasks and/or deadlines.

The docketing environment 300 can include, for example, an electronic communication system 310, a file database 320, an intake tool 330, a guided reminder tool 350 with a user interface 355, an automated or semi-automated docketing system 360, and file records 370.

The electronic communication system 310 can be an e-mail, text, audio, or other means of communicating with internal and external personnel and entities, for example. The electronic communication system 310 can be a user-accessible system for receiving and/or sending messages, such as through a user interface or other computer. The electronic communication system 310 can be, for example, an e-mail server or other communication system.

The file database 320 can include a repository of files or projects being working on by the company. The file database 320 can be, for example, a public or private database, such as a governmental run database. In an example, the PTO PAIR database can be accessed. In an example, ESPACENET can be accessed. In some cases, other database can be used. In some cases, privately run and updated databases can be accessed. The file database 320 can also include information on various files of interest for the business. For example, the file database 320 can include information about patent applications or trademark applications. Such information can, for example, include communications from a governmental agency, responses filed by the company, and other official documents.

The intake tool 330 can include a program or application for receiving electronic communications and associated documents or files. In some cases, the intake tool 330 can be configured to manually or automatically received incoming patent documents or events.

The docketing system 360 can be an automated or semi-automated docketing system, such as the docketing system discussed above with reference to FIG. 1. The docketing system 360 can be in communication with the intake tool 330 and the guided reminder tool 350, and can receive documents, tasks, and communications with the intake tool 330. The docketing system 360 can communicate with and update the file records 370.

The file records 370 can, for example, be a local or cloud-based file storage system including information of files and projects being worked on at or monitored by the company. The file records 370 can contain historical records, such as past events, communications, and decisions in each file.

The task reminder tool 340 can be a tool for providing reminders to a user, such as reminders related to upcoming tasks and/or deadlines in a matter. The task reminder tool 340 can be in communication with the docketing system 360 to receive and push out reminder information to a user. For example, the upcoming task can be a foreign filing deadline, a provisional patent conversion deadline, an issue fee deadline, a divisional case filing deadline, a continuation case filing deadline, an office action response deadline, a fee payment deadline, or other deadlines. In any of these cases, the task reminder tool 340 can push out a reminder related to the task.

The task reminder tool 340 can, for example, push a reminder to an application or software program, such as a PC program, a smartphone app, or other program. In some cases, providing a reminder of the upcoming task can include sending a reminder via an electronic communication, such as a text or e-mail. In any format, the reminder can include an embedded link to the guided reminder tool.

The guided reminder tool 350 can be configured to work with the task reminder tool 340 to provide user-interactive recommendations for docket tasks. The guided reminder tool 350 can include a reminder wizard 410 and a recommendation engine 420.

The guided reminder tool 350 can be launched, for example, through a link in a reminder provided by the task reminder tool 340. In some cases, the guided reminder tool 350 can be manually launched by a user. In some cases, a user can select a case, matter, task, or deadline within the guided reminder tool 350.

The guided reminder tool 350 can include a user interface for user interaction therewith. The guided reminder tool 350 can provide information to the user on the user interface, such as bibliographic information related to the task of interest. For example, the case or matter number, title, inventors, and other information can be accessible in the guided reminder tool 350. The guided reminder tool 350 can, in some cases, include historical information related to an upcoming task. In some cases, the guided reminder tool 350 can provide docketed information related to the upcoming task. In some cases, the guided reminder tool 350 can provide such information natively in the guided reminder tool 350 user interface. In some cases, the guided reminder tool 350 can provide one or more links to such information, such as stored in the docketing system 360.

The reminder wizard 410 can be configured to guide the user through a series of considerations and/or questions regarding a specific task or deadline, such as to collect appropriate information and allow the recommendation engine 420 to provide one or more analyses and recommendations.

The reminder wizard 410 can provide a series of considerations for the user to deliberate, such as manufacturing, sales, associated commercial products, portfolio priority, portfolio size, portfolio status, case lifetime, term of cases in the portfolio, domestic pending family members, international pending family members, business strategic benefit, costs of action, fees, potential success of action, prosecution history, and combinations thereof. FIG. 5 depicts potential such considerations used with a guided reminder tool in an example.

In some cases, the reminder wizard 410 can produce these considerations as questions to the user, such as to allow user input. In some cases, the reminder wizard 410 can produce these considerations according to predetermined parameters. The reminder wizard 410 can assign weights to the various considerations according to certain parameters. For example, a particular client may weigh the commercial products questions as higher priority than costs considerations. In this case, the commercial products questions may weight higher than prohibitive costs.

The recommendation engine 420 can synthesize the considerations from the reminder wizard 410, taking into account user inputs as well as any other considerations. For example, the user may have answered questions related to commercial products and portfolio priority. These answers may be taken into consideration. Additionally, the particular client may have some preset considerations, such as international pending family members. The recommendation engine 420 can take these various considerations into account to provide one or more recommendations for action to the user.

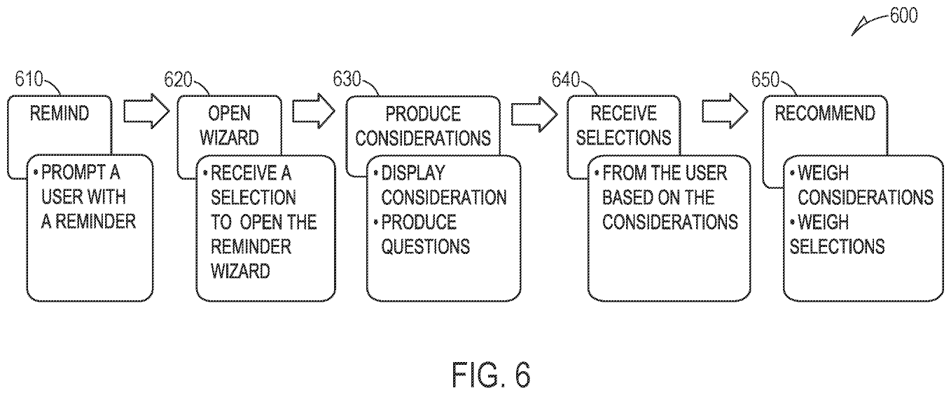

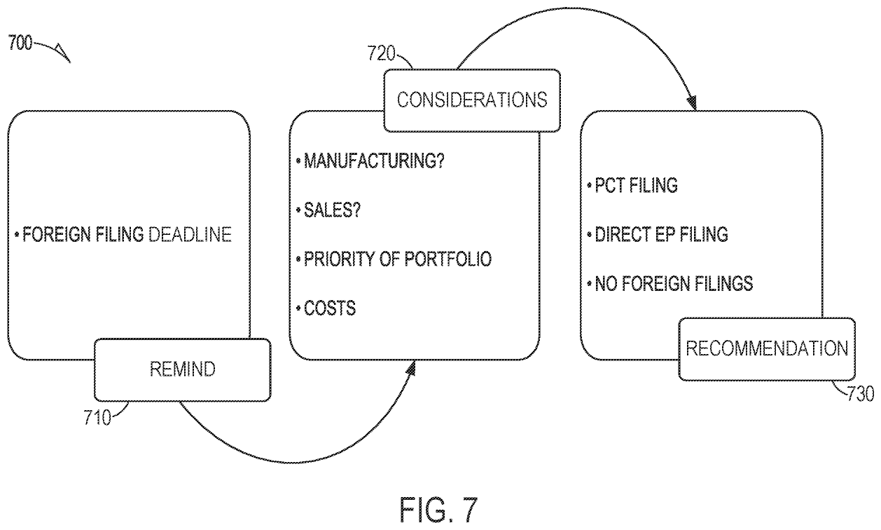

FIG. 6 depicts a schematic of a method 600 of using a guided reminder tool 350 in an example. In the method 600, the guided reminder tool 350 can walk a user through a decision-making process to help recommend whether or not the user should take an action in a patent prosecution context. For example, the method 600 can be used to determine whether it is recommended to file a PCT application. Some illustrative examples are provided below and discussed with reference to FIGS. 7-9.

In the method 600, the guided reminder tool 350 can be used in regard to a task with an upcoming deadline. In this case, the task can be associated with a matter to which the user is assigned. In an example, the upcoming task can include a foreign filing deadline, a provisional patent conversion deadline, an issue fee deadline, a divisional case filing deadline, a continuation case filing deadline, an office action response deadline, a fee payment deadline, or other deadlines.

First, at block 610, the system can remind the user of the upcoming task with the associated deadline. This can be done, for example, by a docket task reminder program or tool, which may be separate or integrated with the guided reminder tool.

Next, at block 620, the reminder wizard 410 can provide information related to the task on a user interface of the reminder wizard 410. In some cases, the user can click on a link in the reminder to launch the reminder wizard 410 and populate the information related to the task. In some cases, the user can natively open the reminder wizard 410 and select the task to be investigated through search. In some cases, the user can natively open the reminder wizard 410 and see upcoming tasks in a task list, upon which the user can select the task. In some cases, the guided reminder tool can be automatically launched to provide reminders and show associated tasks.

At block 630, the guided reminder tool 350 can produce one or more considerations for the user related to the task and the upcoming deadline. In an example, the one or more considerations can include questions related to manufacturing, sales, associated commercial products, portfolio priority, portfolio size, portfolio status, case lifetime, term of cases in the portfolio, domestic pending family members, international pending family members, business strategic benefit, costs of action, fees, potential success of action, prosecution history, and combinations thereof.

At block 640, the guided reminder tool 350 can receive input from the user related to the one or more considerations.

In some cases, producing one or more considerations comprises providing one or more prompted questions for the user on the user interface. For example, the guided reminder tool 350 can ask whether the product(s) related to the matter are priority or strategic for the client's company. In this case, receiving input can include receiving answers to the one or more prompted questions from the user through the user interface.

Answers to such questions can allow the guided reminder tool 350 to score the desirability of a particular action. For example, the answers to the questions can help the guided reminder tool 350 determine whether such an action is beneficial for the client. The considerations and questions can be tailored to the client. For example, a particular client might weight budgetary concerns higher, while a different client might weight international coverage higher.

The questionnaire can be weighted such that the guided reminder tool 350 can synthesize the information to provide a preferred course of action. At block 650, the guided reminder tool 350 can weigh the one or more considerations according to predetermined parameters. These parameters can be situated based on the particular client.

In some cases, weighing the one or more considerations can include weighing user input related to the one or more considerations. In some cases, weighing the one or more considerations can include weighing additional considerations without user input.

At block 650, the guided reminder tool 350 can recommend to the user a course of action related to the task and the upcoming deadline on the user interface, wherein recommending the course of action is based on the one or more considerations. For example, where an issue fee is due, based on the considerations and question answers, the guided reminder tool 350 may recommend the user file a continuation file.

Producing the one or more considerations can include providing one or more prompts on the user interface for user interaction, such as notifications within the guided reminder tool 350, or notifications by electronic communication. In some cases, recommending a course of action can include providing multiple recommendations.

FIG. 7 depicts a method 700 of using a guided reminder tool in an example. The method 700 can include the steps of reminding 710, taking considerations 720, and producing a recommendation 730.

At step 710, the guided reminder tool can provide a reminder to a user regarding a task. In the example method 700, the task is an upcoming foreign filing deadline. The matter may have a first filing, such as a U.S. case, and according to World Intellectual Property Organization (WIPO) rules, if a corresponding case is going to be filed and claim the original priority date, such action must be taken before the upcoming foreign filing deadline. In this case, a reminder of the upcoming foreign filing deadline can be pushed to the user, which may be the client's patent attorney.

At step 720, the guided reminder tool 350 can take into account considerations regarding the task. The guided reminder tool 350 can ask the user questions and receive corresponding answers. The guided reminder tool 350 can also take into account preset considerations.

For example, in method 700, considerations that the user might take into account when considering whether or not to make a foreign filing prior to the foreign filing deadline can include whether the product corresponding to the filing is manufactured in any foreign jurisdictions, whether the product corresponding to the filing is sold in any foreign jurisdictions, the overall priority of the portfolio to the client, and the cost of filing in a foreign jurisdiction.

In an example, the guided reminder tool 350 can provide questions regarding these considerations. For example, if the user is considering whether to file a direct European Patent Office (EPO) counterpart, whether to file a Patent Cooperation Treaty (PCT) counterpart, or to not file internationally at all, the guided reminder tool 350 can ask questions related to these considerations to help provide insight into whether any of these courses of actions is preferred.

In this example, the guided reminder tool 350 can ask “is the corresponding product manufactured in Europe?” and “is the corresponding product sold in Europe?”, among other questions. The user can answer the questions accordingly. For example, the user could answer “yes” to both questions.

Similarly, the guided reminder tool 350 can ask questions such as “is the corresponding product manufactured outside the U.S.? If so, in which locations?” and “is the corresponding product sold outside the U.S.? If so, in which locations?” The user can answer the questions accordingly. For example, the user could answer “yes, Europe” to both questions.

At step 730, the guided reminder tool 350 can provide a recommendation to the user. The guided reminder tool 350 can synthesize the provided answers and the preset considerations, according to predetermined parameters. The predetermined parameters can be specific to the client. The guided reminder tool 350 can use these to push a recommendation to the user.

In the example of method 700, the guided reminder tool 350 would analyze the question's answers. In this case, the corresponding product is both manufactured and sold in Europe, but not elsewhere internationally. The guided reminder tool 350 can factor the cost of filing directly in Europe versus filing a PCT application. With these factors in mind, the guided reminder tool 350 can recommend that a direct EP filing is made, but not a PCT filing.

This can be presented as a recommendation for the user to review. The guided reminder tool 350 can present the relevant information and overall recommendation to the user on the user interface, and/or in a notification or electronic communication. This can help the user make an informed decision on how to proceed.

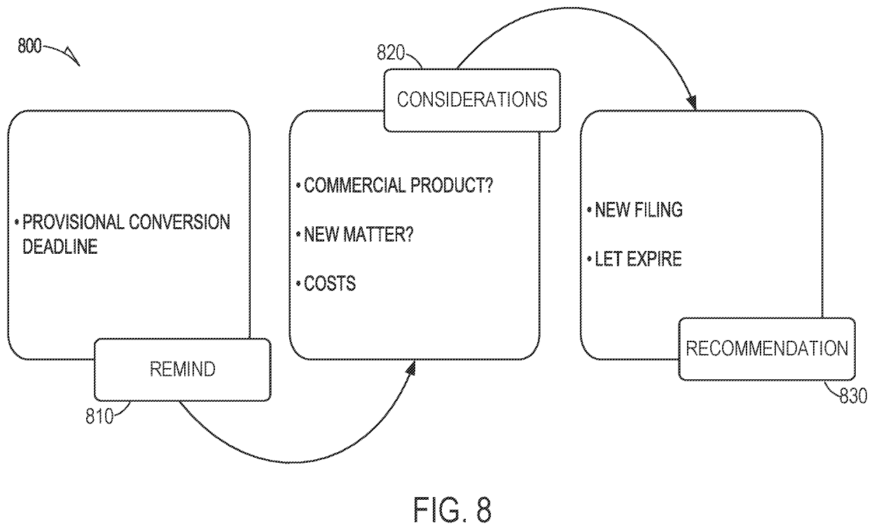

FIG. 8 depicts a method 800 of using a guided reminder tool 350 in an example. The method 800 can include the steps of reminding 810, taking considerations 820, and producing a recommendation 830.

At step 810, the guided reminder tool 350 can provide a reminder to a user regarding a task. In the example of method 800, the reminder can notify a user of an upcoming conversion deadline for a U.S. provisional filing. When the deadline comes, the user can either decide to file another application claiming priority to the U.S. provisional, or let the case expire.

At step 820, the guided reminder tool 350 can take into account considerations regarding the task. The guided reminder tool 350 can ask the user questions and receive corresponding answers. The guided reminder tool 350 can also take into account preset considerations.

In the method 800, the guided reminder tool 350 can ask the user several questions regarding the upcoming conversion deadline. For example, the guided reminder tool can ask “does the application correspond to a current or potential commercial product?” and “is there new matter for inclusion in filing?” The user might answer the questions with “yes” and “yes”.

At step 830, the guided reminder tool 350 can provide a recommendation to the user. The guided reminder tool 350 can synthesize the provided answers and the preset considerations, according to predetermined parameters. The predetermined parameters can be specific to the client. The guided reminder tool 350 can use these to push a recommendation to the user. For example, in method 800, the guided reminder tool 350 can use answers to the above questions to determine that a new non-provisional filing is recommended.

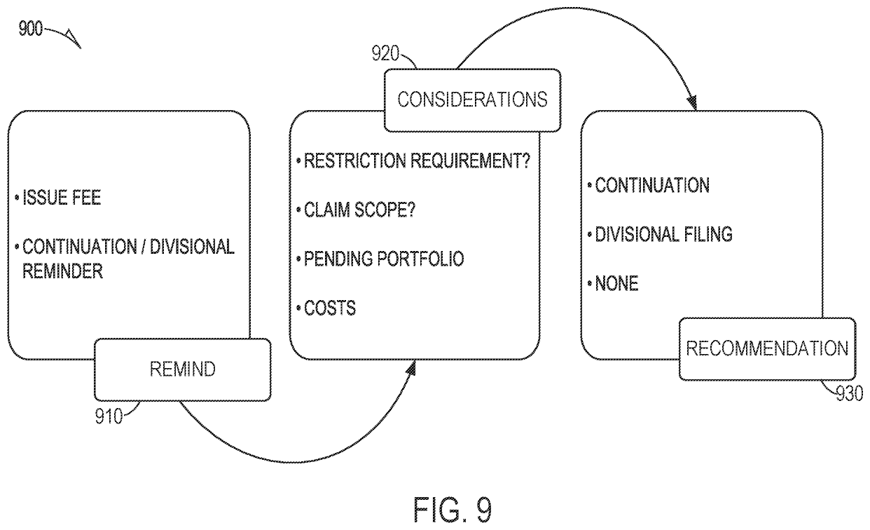

FIG. 9 depicts a method 900 of using a guided reminder tool 350 in an example. The method 900 can include the steps of reminding 910, taking considerations 920, and producing a recommendation 930.

At step 910, the guided reminder tool can provide a reminder to a user regarding a task. For example, in method 900, the issue fee deadline can be approaching, which can induce a task such as providing a continuation or divisional filing recommendation.

At step 920, the guided reminder tool 350 can take into account considerations regarding the task. The guided reminder tool 350 can ask the user questions and receive corresponding answers. The guided reminder tool 350 can also take into account preset considerations.

For example, in method 900, the guided reminder tool 350 can ask questions such as “was there a restriction requirement?” “is the claim scope broad?” and “are other cases pending in the portfolio?”

At step 930, the guided reminder tool 350 can provide a recommendation to the user. The guided reminder tool 350 can synthesize the provided answers and the preset considerations, according to predetermined parameters. The predetermined parameters can be specific to the client. The guided reminder tool 350 can use these to push a recommendation to the user.

In the example method 900, a user might answer “no” there was not a restriction requirement, and “yes” the claim scope is broad. In this case, the guided reminder tool 350 might recommend no continuation or divisional filing.

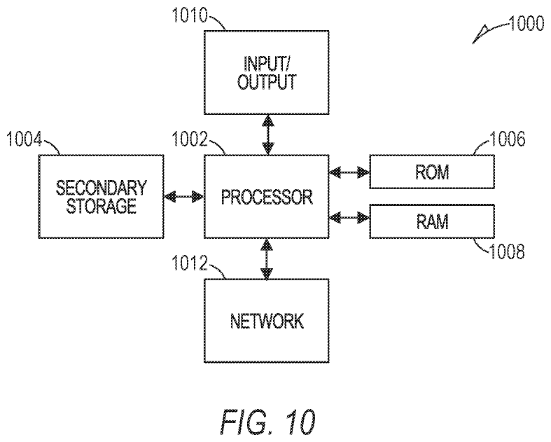

FIG. 10 is a block diagram of a typical, general-purpose computer 1000 that may be programmed into a special purpose computer suitable for implementing one or more embodiments of the data interchange system disclosed herein. The data interchange system described above may be implemented on any general-purpose processing component, such as a computer with sufficient processing power, memory resources, and communications throughput capability to handle the necessary workload placed upon it. The computer 1000 include a processor 1002 (which may be referred to as a central processor unit or CPU) that is in communication with memory devices including secondary storage 1004, read only memory (ROM) 1006, random access memory (RAM) 1008, input/output (I/O) devices 1010, and network connectivity devices 1012. The processor 1002 may be implemented as one or more CPU chips or may be part of one or more application specific integrated circuits (ASICs).

The secondary storage 1004 is typically comprised of one or more disk drives or tape drives and is used for non-volatile storage of data and as an over-flow data storage device if RAM 1008 is not large enough to hold all working data. Secondary storage 1004 may be used to store programs that are loaded into RAM 1008 when such programs are selected for execution. The ROM 1006 is used to store instructions and perhaps data that are read during program execution. ROM 1006 is a non-volatile memory device that typically has a small memory capacity relative to the larger memory capacity of secondary storage 1004. The RAM 1008 is used to store volatile data and perhaps to store instructions. Access to both ROM 1006 and RAM 1008 is typically faster than to secondary storage 1004.

The devices described herein may be configured to include computer-readable non-transitory media storing computer-readable instructions and one or more processors coupled to the memory, and when executing the computer-readable instructions configure the computer 1000 to perform method steps and operations described above with reference to FIG. 3 to FIG. 9. The computer-readable non-transitory media includes all types of computer-readable media, including magnetic storage media, optical storage media, flash media, and solid-state storage media.

It should be further understood that software including one or more computer-executable instructions that facilitate processing and operations as described above with reference to any one or all of steps of the disclosure may be installed in and sold with one or more servers and/or one or more routers and/or one or more devices within consumer and/or producer domains consistent with the disclosure. Alternatively, the software may be obtained and loaded into one or more servers and/or one or more routers and/or one or more devices within consumer and/or producer domains consistent with the disclosure, including obtaining the software through physical medium or distribution system, including, for example, from a server owned by the software creator or from a server not owned but used by the software creator. The software may be stored on a server for distribution over the Internet, for example.

Also, it will be understood by one skilled in the art that this disclosure is not limited in its application to the details of construction and the arrangement of components set forth in the description or illustrated in the drawings. The embodiments herein are capable of other embodiments, and capable of being practiced or carried out in various ways. Also, it will be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Further, terms such as up, down, bottom, and top are relative, and are employed to aid illustration, but are not limiting.

The components of the illustrative devices, systems and methods employed in accordance with the illustrated embodiments may be implemented, at least in part, in digital electronic circuitry, analog electronic circuitry, or in computer hardware, firmware, software, or in combinations of them. These components may be implemented, for example, as a computing program product such as a computing program, program code or computer instructions tangibly embodied in an information carrier, or in a machine-readable storage device, for execution by, or to control the operation of, data processing apparatus such as a programmable processor, a computer, or multiple computers.

A computing program may be written in any form of programming language, including compiled or interpreted languages, and it may be deployed in any form, including as a stand-alone program or as a module, component, subroutine, or other unit suitable for use in a computing environment. A computing program may be deployed to be executed on one computer or on multiple computers at one site or distributed across multiple sites and interconnected by a communication network. Also, functional programs, codes, and code segments for accomplishing the techniques described herein may be easily construed as within the scope of the present disclosure by programmers skilled in the art. Method steps associated with the illustrative embodiments may be performed by one or more programmable processors executing a computing program, code or instructions to perform functions (e.g., by operating on input data and/or generating an output). Method steps may also be performed by, and apparatus may be implemented as, special purpose logic circuitry, e.g., an FPGA (field programmable gate array) or an ASIC (application-specific integrated circuit), for example.

The various illustrative logical blocks, modules, and circuits described in connection with the embodiments disclosed herein may be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computing program include, by way of example, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computing program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory may be supplemented by or incorporated in special purpose logic circuitry.

Those of skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor may read information from, and write information to, the storage medium. In the alternative, the storage medium may be integral to the processor. In other words, the processor and the storage medium may reside in an integrated circuit or be implemented as discrete components.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory [EEPROM]), and/or any suitable combination thereof. The term “machine-readable medium” should be taken to include a single medium or multiple media (e.g., a centralized or distributed database, or associated caches and servers) able to store processor instructions. The term “machine-readable medium” shall also be taken to include any medium, or combination of multiple media, that is capable of storing instructions for execution by one or more processors, such that the instructions, when executed by one or more processors cause the one or more processors to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” as used herein excludes signals per sc.

### Various Notes & Examples

A method of providing recommendations for project tasks with a guided reminder tool comprising: reminding a user of an upcoming task with an associated deadline; providing information related to the upcoming task on a guided reminder tool user interface; producing one or more considerations for the user related to the upcoming task and the associated deadline; receiving input from the user related to the one or more considerations; weighing the one or more considerations according to predetermined parameters; and recommending a course of action related to the upcoming task and the associated deadline to the user on the guided reminder tool user interface, wherein recommending the course of action is based on the one or more considerations.

In Example 2, the subject matter of Example 1 optionally includes wherein the upcoming task is associated with a matter to which the user is assigned.

In Example 3, the subject matter of any one or more of Examples 1-2 optionally includes wherein producing one or more considerations comprises providing one or more prompted questions for the user on the guided reminder tool user interface.

In Example 4, the subject matter of Example 3 optionally includes wherein receiving input comprises receiving answers to the one or more prompted questions from the user through the guided reminder tool user interface.

In Example 5, the subject matter of any one or more of Examples 1-4 optionally includes wherein reminding the user of the upcoming task comprises pushing a reminder to the user from a docket reminder tool.

In Example 6, the subject matter of any one or more of Examples 1-5 optionally includes wherein reminding the user of the upcoming task comprises pushing a reminder to a software application.

In Example 7, the subject matter of any one or more of Examples 1-6 optionally includes wherein reminding the user of the upcoming task comprises sending a reminder via an electronic communication.

In Example 8, the subject matter of any one or more of Examples 1-7 optionally includes wherein reminding the user of the upcoming task comprises providing a reminder with an embedded link to the guided reminder tool.

In Example 9, the subject matter of Example 8 optionally includes wherein providing information related to the upcoming task on the guided reminder tool user interface comprises opening the guided reminder tool user interface from the embedded link.

In Example 10, the subject matter of any one or more of Examples 1-9 optionally includes wherein providing information related to the upcoming task on the guided reminder tool user interface comprises providing bibliographic information related to the upcoming task.

In Example 11, the subject matter of any one or more of Examples 1-10 optionally includes wherein providing information related to the upcoming task on the guided reminder tool user interface comprises providing historical information related to the upcoming task.

In Example 12, the subject matter of any one or more of Examples 1-11 optionally includes wherein providing information related to the upcoming task on the guided reminder tool user interface comprises providing docketed information related to the upcoming task.

In Example 13, the subject matter of any one or more of Examples 1-12 optionally includes wherein producing one or more considerations comprises providing one or more prompts on the guided reminder tool user interface for user interaction.

In Example 14, the subject matter of any one or more of Examples 1-13 optionally includes wherein the upcoming task comprises a foreign filing deadline, a provisional patent conversion deadline, an issue fee deadline, a divisional case filing deadline, a continuation case filing deadline, an office action response deadline, a fee payment deadline, or other deadlines.

In Example 15, the subject matter of any one or more of Examples 1-14 optionally includes wherein the one or more considerations comprise questions related to manufacturing, sales, associated commercial products, portfolio priority, portfolio size, portfolio status, case lifetime, term of cases in a portfolio, domestic pending family members, international pending family members, business strategic benefit, costs of action, fees, potential success of action, prosecution history, and combinations thereof.

In Example 16, the subject matter of any one or more of Examples 1-15 optionally includes wherein weighing the one or more considerations comprises weighing user input related to the one or more considerations.

In Example 17, the subject matter of Example 16 optionally includes wherein weighing the one or more considerations comprises weighing additional considerations without user input.

In Example 18, the subject matter of any one or more of Examples 1-17 optionally includes wherein recommending a course of action comprises providing multiple recommendations.

Example 19 is a docketing system including a guided reminder tool comprising: an automated or semi-automated docketing system; a docket task reminder tool in communication with the docketing system, the docketing task reminder tool for providing reminders to a user regarding docket tasks; the guided reminder tool configured to work with the docket task reminder tool to provide user-interactive recommendations for docket tasks.

In Example 20, the subject matter of Example 19 optionally includes wherein the guided reminder tool comprises a reminder wizard and a recommendation engine.

Each of these non-limiting examples can stand on its own or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples”. Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B”, “B but not A”, and “A and B”, unless otherwise indicated. In this document, the terms “including” and “in which” are used as the plain-English equivalents of the respective terms “comprising” and “wherein”. Also, in the following claims, the terms “including” and “comprising” are open-ended—that is, a system, device, article, composition, formulation, or process that includes elements in addition to those listed after such a term in a claim are still deemed to fall within the scope of that claim. Moreover, in the following claims, the terms “first”, “second”, and “third”, etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as: microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method of providing recommendations for project tasks with a guided reminder tool comprising:
reminding a user of an upcoming task with an associated deadline;
providing information related to the upcoming task on a guided reminder tool user interface;
producing one or more considerations for the user related to the upcoming task and the associated deadline;
receiving input from the user related to the one or more considerations;
weighing the one or more considerations according to predetermined parameters; and
recommending a course of action related to the upcoming task and the associated deadline to the user on the guided reminder tool user interface,
wherein recommending the course of action is based on the one or more considerations.

2. The method of claim 1, wherein the upcoming task is associated with a matter to which the user is assigned.

3. The method of claim 1, wherein producing one or more considerations comprises providing one or more prompted questions for the user on the guided reminder tool user interface.

4. The method of claim 3, wherein receiving input comprises receiving answers to the one or more prompted questions from the user through the guided reminder tool user interface.

5. The method of claim 1, wherein reminding the user of the upcoming task comprises pushing a reminder to the user from a docket reminder tool.

6. The method of claim 1, wherein reminding the user of the upcoming task comprises pushing a reminder to a software application.

7. The method of claim 1, wherein reminding the user of the upcoming task comprises sending a reminder via an electronic communication.

8. The method of claim 1, wherein reminding the user of the upcoming task comprises providing a reminder with an embedded link to the guided reminder tool.

9. The method of claim 8, wherein providing information related to the upcoming task on the guided reminder tool user interface comprises opening the guided reminder tool user interface from the embedded link.

10. The method of claim 1, wherein providing information related to the upcoming task on the guided reminder tool user interface comprises providing bibliographic information related to the upcoming task.

11. The method of claim 1, wherein providing information related to the upcoming task on the guided reminder tool user interface comprises providing historical information related to the upcoming task.

12. The method of claim 1, wherein providing information related to the upcoming task on the guided reminder tool user interface comprises providing docketed information related to the upcoming task.

13. The method of claim 1, wherein producing one or more considerations comprises providing one or more prompts on the guided reminder tool user interface for user interaction.

14. The method of claim 1, wherein the upcoming task comprises a foreign filing deadline, a provisional patent conversion deadline, an issue fee deadline, a divisional case filing deadline, a continuation case filing deadline, an office action response deadline, a fee payment deadline, or other deadlines.

15. The method of claim 1, wherein the one or more considerations comprise questions related to manufacturing, sales, associated commercial products, portfolio priority, portfolio size, portfolio status, case lifetime, term of cases in a portfolio, domestic pending family members, international pending family members, business strategic benefit, costs of action, fees, potential success of action, prosecution history, and combinations thereof.

16. The method of claim 1, wherein weighing the one or more considerations comprises weighing user input related to the one or more considerations.

17. The method of claim 16, wherein weighing the one or more considerations comprises weighing additional considerations without user input.

18. The method of claim 1, wherein recommending a course of action comprises providing multiple recommendations.

19. A docketing system including a guided reminder tool comprising:
an automated or semi-automated docketing system;
a docket task reminder tool in communication with the docketing system, the docketing task reminder tool for providing reminders to a user regarding docket tasks;
the guided reminder tool configured to work with the docket task reminder tool to provide user-interactive recommendations for docket tasks.

20. The docketing system of claim 19, wherein the guided reminder tool comprises a reminder wizard and a recommendation engine.
